(19) United States
(12) Patent Application Publication
(10) Pub. No.: US 2008/0089492 A1
(43) Pub. Date: Apr. 17, 2008

(54) Circuit Arrangement for Suppressing Interference Signals in the Receive Branch of a Modem of a Household Appliance

(75) Inventors: Udo Hertel, Regensburg (DE); Roman Makhthyuk, Alteglofsheim (DE); Simon Piermeier, Regensburg (DE)

Correspondence Address: LERNER GREENBERG STEMER LLP, P O BOX 2480, HOLLYWOOD, FL, 33022-2480, US

(73) Assignee: BSH BOSCH UND SIEMENS HAUSGERÄTE GMBH, Munchen (DE)

(21) Appl. No.: 11/660,077

(22) PCT Filed: Aug. 1, 2005
(86) PCT No.: PCT/EP05/53743

§ 371 Date: Apr. 23, 2007

(30) Foreign Application Priority Data
Aug. 11, 2004 (DE) 10 2004 039 061.4

(51) Int. Cl. H04M 11/00

(52) U.S. Cl. 379/93.01

(57) ABSTRACT

A circuit arrangement for suppressing interference signals in the receive branch of a modem containing a transmit branch and the receive branch, of a household appliance equipped with a transmitting device for transmitting and a receiving device for receiving data signals, using a bandpass filter. When using a receive circuit of the modem with an input circuit having a relatively high input impedance compared with the impedance of a useful signal source delivering data signals, to which data signals are supplied by the useful signal source having a relatively low impedance in relation to said input impedance and in the presence of the interference signal sources which deliver the interference signals with a relatively high impedance in relation to the impedance of the useful signal source delivering the data signals, a bandpass filter is connected in parallel to said input circuit, the resonance frequency of said bandpass filter being set to such a value that the frequency of the respective interference signal is either higher or lower than the relevant resonance frequency.

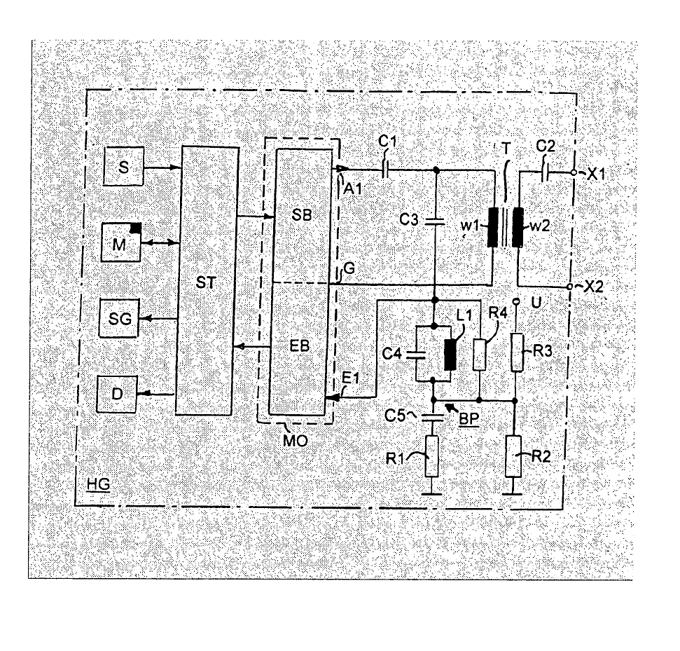

The invention relates to a circuit arrangement for suppressing interference signals in the receive branch of a modem containing a transmit branch and the receive branch, of a household appliance equipped with a transmitting device for transmitting and a receiving device for receiving data signals, using a filter arrangement.

In a known circuit arrangement for transmitting data signals from and/or to household appliances (U.S. Pat. No. 6,590,493 B1), in each case a combination of individual household appliances is connected to a mains AC line arrangement via a separate filter arrangement. The filter arrangements of various combinations of household appliances are dimensioned in such a manner that the data signals transmitted in one combination of household appliances cannot reach the household appliances belonging to another combination of household appliances. LC low-pass filters of different configurations are used for the relevant filter arrangement. However, no further details are known in this connection relating to measures for eliminating or suppressing interference signals which occur in the receive branch of the respective household appliance.

In a further known circuit arrangement for transmitting data signals from and/or to household appliances (U.S. Pat. No. 6,396,392 B1), the respective transmitting/receiving device comprises a modem connected to the respective household appliance which is connected to a mains AC line arrangement via a coupler. Various filters such as low-pass filters and bandpass filters are contained in the modem and also in the coupler. However, no further details are known in this connection relating to measures for suppressing interference signals which occur in the receive branch of the respective modem.

Finally, a communication system working with a data modem is also known (DE 38 30 338 C2) wherein undesirable signal frequencies of a so-called secondary channel (300 to 350 Hz band) are suppressed in the respective modem receive branch by means of a suppression filter and only a so-called main channel signal is transmitted in a frequency band of 600 to 3000 Hz. Although nothing is known in this connection about the suppression of interference signals in the receive branch of the respective data modem, the relevant circuit measure; namely the use of a suppression filter for a certain frequency range could also be used to suppress interference signals which occur at a frequency different from a useful signal receiving frequency. If such interference signals with frequencies above and below a useful signal receiving frequency are to be taken into account, however a plurality of correspondingly dimensioned suppression filters should be provided which means a not inconsiderable expenditure on circuitry which should actually be avoided.

In a modem of the type specified initially, interference signals pose considerable problems even when they are output by relatively high-impedance interference signal sources (e.g. with Ri>10 kΩ or >100 kΩ) when a transmitting/receiving IC module is used in the relevant modem whose receive branch is relatively broad-band and high-impedance and has an input impedance of, for example, 150 kΩ. These conditions apply, for example, to the ST7538 IC module from STMicroelectronics which is provided for use as a transmitting/receiving module in a modem of a household appliance. If interference signals from relatively high-impedance interference signal sources occur in the receive branch of such a module, unless separate measures are taken, these interference signals would block the input circuit in the receive branch of the relevant IC module to a certain extent so that the actual useful signal could no longer be recognised by the relevant receive branch, although it optionally occurs at a useful signal frequency different from the interference signal frequencies, and is output by a relatively low-impedance useful signal source (e.g. with Ri=1 Ω).

Interference signals of the type mentioned previously can comprise pulsed interference signals which occur on the respective modem receive line, which are supplied from other appliances, but optionally are also produced in the household appliance containing the relevant modem, as well as low-frequency interference signals which occur at frequencies of n times the mains AC frequency, where n≧1. The afore-mentioned pulsed interference signals can comprise, for example, harmonics of the switching frequency of a switching power supply for the modem of a household appliance. For example, if the switching mains frequency is 44 kHz, the frequency of the third harmonic of this switching frequency is 132 kHz; it is thus quite clearly in the frequency range of the CENELEC band C (125-140 kHz) which is specified for so-called power-line communications, that is for power line communication in Europe.

It is now the object of the invention to further develop a circuit arrangement of the type specified initially in such a manner that interference signals occurring in the receive branch of said modem can be effectively suppressed with relatively low expenditure on circuitry, which signals are coupled into said receive branch of the modem or fed thereto electrically and/or magnetically from relatively high-impedance interference signal sources.

The object indicated hereinbefore is achieved in a circuit arrangement of the type specified initially according to the invention whereby when using a receive circuit of the modem with an input circuit having a relatively high input impedance, a bandpass filter is connected in parallel to this circuit, the resonance frequency of said bandpass filter being set to such a value that the frequency of the respective interference signal is either higher or lower than the relevant resonance frequency.

The invention has the advantage that with a particularly low expenditure on circuitry, namely merely by connecting a bandpass filter in parallel to the input circuit of said receive circuit of the modem and by specifying the resonance frequency of the relevant bandpass filter at a value above or below the respective interference signal frequency, the circuit input of the receive circuit of the modem having a relatively high input impedance (of, for example, about 150 kΩ) has a relatively low impedance (of, for example, 1 kΩ) in the frequency range of the interference signals. That is, the circuit input of the afore-mentioned receiving device of the modem is made relatively low-impedance for frequencies above and below the resonance frequency of said bandpass filter. As a result, on account of the afore-mentioned low impedance of the circuit input of the receiving device of the modem, interference signals originating from relatively low-impedance interference signal sources (e.g. with Ri>10 kΩ) or >100 kΩ) are reduced in their voltages and thus can no longer disadvantageously influence the receive branch of the afore-mentioned modem; they are therefore sufficiently suppressed. In addition, in particular in cases where the relevant interference signals originate from the household appliance or the modem or the power supply unit for the modem and are coupled capacitively and/or magnetically into the receive circuit of the modem, expensive shielding measures at transmitters or in the receive branch of the modem and the use of magnetically shielded components and/or shielding sheets can be eliminated.

In other words, this means that advantageously according to the invention, the frequency selectivity of the bandpass filter is not primarily used to transmit the useful signal at the bandpass filter resonance frequency but the effect is used here that the bandpass filter has a low impedance in the range of the interference signals which have a frequency spacing from its resonance frequency and as a result of its connection in parallel to the input circuit of the receive circuit of the modem, makes this input circuit low-impedance. As a result, the voltages of the relevant interference signals coupled into the signal input of the input circuit of the modem by relatively high-impedance interference signal sources are reduced and thus no longer block the receive circuit of the modem. The useful signals supplied by a relatively low-impedance useful signal source (e.g. with Ri≈1 Ω) can thus be recognised by the relevant receive circuit of the modem and recorded.

At this point, it may be noted that the useful signal can be transmitted at the resonance frequency of said bandpass filter or outside this resonance frequency. In the first-mentioned case, the voltage of the useful signal at the impedance maximum of the bandpass filter decrease at this and can easily be recognised and processed in the receive circuit of the modem. In the second-mentioned case, since the useful signal is output be a relatively low-impedance useful signal source whose internal resistance is at least low compared with the internal resistance of the respective relatively high-impedance interference signal source, the useful signal is easily recognised in the receive circuit of the modem and also processed. In this case, a useful signal is even recognised and evaluated in the relevant receive circuit of the modem when an interference signal having the same frequency from a relatively high-impedance interference signal source is superposed on said useful signal.

The bandpass filter is appropriately formed by an LC parallel circuit which is capacitively coupled to the receive branch of the modem. This yields the advantage of a bandpass filter which is particularly simple to implement.

An ohmic resistance is preferably located parallel to the LC parallel circuit of the bandpass filter and a DC voltage which determines the working point of the receive circuit is supplied to the end of the LC parallel circuit and said ohmic resistance facing away from the transmit-receive branch. These measures result in the advantage of a particularly simple adjustment of the working point of the afore-mentioned receive circuit of the modem and at the same time, a desirable influencing of the input impedance of the relevant receive circuit of the modem.

A tap of an ohmic voltage divider located between a supply voltage and a reference potential, in particular earth potential, is preferably used to provide the afore-mentioned DC voltage. This yields the advantage of a particularly simple provision of the afore-mentioned DC voltage.

A particularly favourable circuit structure is obtained if the bandpass filter with its end facing away from the end connected to a signal input connection of the receive circuit of the modem lies at a reference potential, in particular earth potential, via a capacitor and an ohmic resistance located in series therewith. This circuit measure can advantageously rapidly compensate for any oscillation which occurs during the switching process from transmitting operation to receiving operation and at the same time, the bandpass filter is decoupled in terms of DC voltage from the DC voltage source providing the working point of the receive circuit of the modem.

As an additional effective measure for suppressing interference signals in the receive branch of a modem of the type considered hereinbefore, it has proved to be particularly advantageous when using a transmit/receive IC module in the relevant modem or as its transmit and receive circuit if all the connections of the relevant IC module not required for the transmit and receive operation of the modem are set at a defined potential. This measure which supplements the preceding measure has the result that no interference signals can be coupled into the receive branch of the modem via connections of the relevant IC module not required for the relevant transmitting and receiving operation. In order to set the connections of the aforementioned IC module not required for the transmitting and receiving operation of the relevant modem at a defined potential, the procedure can be followed, for example, that the relevant connections are each set to a particular potential such as the supply voltage potential or earth potential by means of so-called pull-up resistances or pull-down resistances or are even connected directly to earth of the circuit arrangement.

An exemplary embodiment of the circuit arrangement according to the present invention is explained in detailed hereinafter with reference to a drawing.

Shown schematically in the drawing is a household appliance HG which is equipped with a circuit arrangement for suppressing interference signals in the receive branch of a modem MO, containing a transmit branch and the receive branch of a household appliance HG equipped with a transmitting device for transmitting and a receive device for receiving data signals. The relevant household appliance HG can be any networkable household appliance such as a washing machine, a drier, a cooker, a refrigerator, a heating system etc. A networkable household appliance is understood here as a household appliance which can be connected by means of a transmitting and/or receiving device to a communication network for transmitting various data signals. In the present case, this communication network comprises the AC voltage network from which the supply voltages required for the operation of the respective household appliance are taken. However, it is naturally also possible to use any other network, such as the internet, as the communication network.

The circuit arrangement shown in the drawing contains the modem MO having a transmit branch and a receive branch, which in the present case is shown as containing a transmit module or a transmit circuit SB and a receive module or a receive circuit EB. These modules or circuits SB and EB can comprise a combined commercial transmit-receive module (for example, the mains lead FSK transmit-receive module ST7538 from STMicroelectronics already mentioned in the introduction—see the publication of this company dated June 2003).

Connected to the afore-mentioned modem MO is a control device ST, which in this case belongs to a transmitting device and a receiving device of the circuit arrangement. In the present case, in addition to the control device ST, the transmitting device of the relevant circuit arrangement comprises one or more sensors S provided in the household appliance, for example, to detect one or more parameters of state of the household appliance HG and a memory M in which data signals can be stored in the form of status signals and/or working programs of the relevant household appliance HG. In addition to the control device ST, the receiving device of the relevant circuit arrangement comprises, for example, one or more control elements SG, a display device D, such as an LCD display device, for example, and the previously mentioned memory M. Data signals can be sent to the relevant control elements SG in the afore-mentioned receive branch; data signals transmitted in the receive branch can also be stored in the afore-mentioned memory M and displayed by the display device D. The data signals transmitted in the receive branch can, for example, comprise test signals in the course of carrying out remote diagnoses or new working programs or parts thereof for updating the working programs of the household appliance HG stored in the afore-mentioned memory M.

A matching transformer T comprising a winding w1 and a capacitor C1 is connected between a signal output connection A1 of the transmitting unit SB and a reference potential connection G, which carries earth potential for example, and which is provided jointly for the transmitting unit SB and the receiving unit EB. The matching transformer comprises a further winding w2 which is firstly connected to a connection x1 via a capacitor C2 and secondly directly to a connection x2 of the circuit arrangement shown. The two windings w1 and w2 of the matching transformer T can have a winding ratio of 1:1. The afore-mentioned communication network will be or is connected to the connections X1, X2.

According to the present invention, a bandpass filter BP is connected capacitively, namely via a coupling capacitor C3 to the connection point between the capacitor C1 and one end of the winding w1 of the matching transformer T—the circuit part comprising the aforementioned connection point represents a transmit branch and a receive branch of the modem MO. In the present case, the bandpass filter BP comprises an LC parallel circuit, consisting of an inductance such as a coil L1 and a capacitive element such as a capacitor C4. In the present case, this LC parallel circuit (L1, C4) whose resonance frequency can be set at 140 kHz, for example, that is at the upper frequency of the CENELEC band C, lies at a reference potential, preferably at earth potential via a capacitor C5 and an ohmic resistance R1 connected in series thereto. The connection point between the afore-mentioned coupling capacitor C3 and the bandpass filter BP is connected to the afore-mentioned signal input connection E1 of the receiving module EB. The relevant bandpass filter BP thus does not lie in the lead-in path but in the lead-out path of the relevant receive branch of the receiving module or the receive circuit EB of the modem MO—it therefore lies parallel to the input circuit of the receive branch or the receive circuit of the receiving component EB of the modem MO.

In the present case, an ohmic resistance R4 is connected in parallel to the afore-mentioned LC parallel circuit, consisting of the coil L1 and the capacitor C4, via which a DC voltage which determines the working point of the relevant receiving module EB is supplied to the receiving module EB of the modem MO. In the present case, this DC voltage is provided by the tap of an ohmic voltage divider consisting of the ohmic resistances R2 and R3 which lie between a connection U carrying a supply voltage of 5 V, for example, and a connection carrying an earth potential. However the afore-mentioned ohmic resistance R4 for supplying the DC voltage which determines the working point of the receiving module EB or the receive circuit of the modem MO forming this, has a certain effect on the low-pass filter BP used according to the invention.

It should be noted at this point that the working point of the receiving module EB can be set in a desired range by suitable selection of the resistance values of the afore-mentioned resistances R2 and R3; the relevant working point can be set, for example, to a point midway between the supply voltage at the connection U and earth by uniformly high values of the resistances R2 and R3, which is particularly desirable with regard to the controllability of the receive module EB by useful signals, which occur, for example, with positive and negative useful signal level components running about a zero level.

The structure of the circuit arrangement shown in the drawing according to one embodiment of the present invention, which has been described hereinbefore, ensures that interference signals from relatively high-impedance interference signal sources are effectively suppressed in the receive branch of the modem MO. As a result of the diminishing impedance on both sides of its resonance frequency—at a resonance frequency of 140 kHz, for example for the bandpass filter BP, however, only the bandpass filter range below the relevant resonance frequency in this C band is used for the CENELEC band C—the bandpass filter BP used in the relevant circuit arrangement only allows the useful signal delivered by a low-impedance useful signal source with the useful signal receiving frequency to carry through to the input connection E1 of the receiving module EB of the modem MO, whilst interference signals from relatively high-impedance interference signal sources (see introduction) are so severely damped by the relevant bandpass filter BP as a result of its low impedance in the interference signal frequency ranges that they can no longer have any perturbing effect on the receiving module EB of the modem; the relevant interference voltages are reduced to a certain extent as a result of the low impedance thereby imparted to the input connection E1 of the receiving module EB by the relevant bandpass filter BP and can not longer perturb the reception of the useful signal by the receiving module EB. Thus, the immunity of the modem MO to interference is increased or its reachability for useful signals in a perturbed environment is improved in a simple manner, namely by using few discrete components. In addition the standard EN 61000-4-4 can be simply adhered to with regard to fast pulsed burst signals.

The useful signals which, as has been mentioned at the beginning, are usually from relatively low-impedance useful signal sources (with, for example, Ri≈1 Ω) and are transmitted over likewise relatively low-impedance transmission distances (with, for example Rt<1 Ω) are easily recognised in the receiving module EB of the modem MO. This even applies to the case where the useful signal receiving frequency and an interference signal frequency are the same.

Finally, it should be noted that only one useful signal receiving frequency has been discussed in each case hereinbefore. However, it is understood that the present invention can naturally also be applied to a circuit arrangement in which interference signals from relatively high-impedance interference signal sources are to be suppressed which occur within or outside a useful signal receiving frequency range comprising a plurality of useful signal frequencies in a cohesive frequency range or in various frequency partial ranges.

### REFERENCE LIST

A1 Signal output connection
BP Bandpass filter
C1 Capacitor
C2 Capacitor
C3 Coupling capacitor
C4 Capacitor
C5 Capacitor
D Display device
E1 Signal input connection
EB Receiving unit, receive circuit
G Reference potential connection
HG Household appliance
L1 Coil
M Memory
MO Modem
R1 Ohmic resistance
R2 Ohmic resistance
R3 Ohmic resistance
R4 Ohmic resistance
S Sensors
SB Transmitting unit, transmit circuit
SG Control elements
ST Control device
T Matching transformer
U Connection
w1 Winding
w2 Winding
x1 Connection
x2 Connection

1-6. (canceled)

7. In a household appliance having a transmitting device for transmitting data signals and a receiving device for receiving data signals, a circuit arrangement for suppressing interference signals in a receive branch of a modem containing a transmit branch and the receive branch, the circuit arrangement comprising:
a receive circuit of the modem with an input circuit having a relatively high input impedance compared to an impedance of a useful signal source emitting data signals, wherein said input circuit receives the data signals from the useful signal source having a relatively low impedance relative to the relatively high input impedance, and wherein interference signal sources deliver the interference signals with a relatively high impedance compared to the impedance of the useful signal source emitting the data signals;
a bandpass filter connected in parallel with said input circuit, said bandpass filter having a resonance frequency set to such a value that a frequency of the respective interference signal is either higher or lower than the resonance frequency.

8. The circuit arrangement according to claim 7, wherein said bandpass filter is an LC parallel circuit capacitively coupled to the receive branch of the modem.

9. The circuit arrangement according to claim 8, which comprises an ohmic resistance connected in parallel with said LC parallel circuit of said bandpass filter, wherein a DC voltage determining a working point of said receive circuit is supplied to an end of said LC parallel circuit, and said ohmic resistance faces away from the receive branch of the receive circuit.

10. The circuit arrangement according to claim 9, which comprises an ohmic voltage divider having a node providing a DC voltage between a supply voltage and a reference potential.

11. The circuit arrangement according to claim 9, which comprises an ohmic voltage divider having a node providing a DC voltage between a supply voltage and ground potential.

12. The circuit arrangement according to claim 7, wherein said bandpass filter has a first end connected to a signal input of said receive circuit of the modem and a second end, and wherein a series circuit of a capacitor and an ohmic resistance are connected between said second end and reference potential.

13. The circuit arrangement according to claim 12, wherein the reference potential is ground potential.

14. The circuit arrangement according to claim 7, wherein a transmit circuit and a receive circuit of the modem is a transmit/receive IC module having a plurality of terminals, and wherein those terminals that are not required for a transmit and receive operation of the modem are set at a defined potential.
